(19) United States
(12) Patent Application Publication
(10) Pub. No.: US 2017/0036111 A1
(43) Pub. Date: Feb. 9, 2017

(54) HEAD POSITION DETECTING APPARATUS AND HEAD POSITION DETECTING METHOD, IMAGE PROCESSING APPARATUS AND IMAGE PROCESSING METHOD, DISPLAY APPARATUS, AND COMPUTER PROGRAM

(71) Applicant: SONY CORPORATION, TOKYO (JP)

(72) Inventors: OSAMU SHIGETA, TOKYO (JP); YUICHI HASEGAWA, TOKYO (JP)

(21) Appl. No.: 15/304,081

(22) PCT Filed: Jan. 19, 2015
(86) PCT No.: PCT/JP2015/051279

§ 371 Date: Oct. 14, 2016

(30) Foreign Application Priority Data
Apr. 22, 2014 (JP) 2014-087849

(51) Int. Cl. A63F 13/525; H04N 13/00; H04N 13/04; G06F 3/01; A63F 13/211; G01B 21/22

(52) U.S. Cl. CPC A63F 13/525; A63F 13/211; G01B 21/22; H04N 13/044; H04N 13/0477; G06F 3/012; H04N 13/0022; A63F 2300/8082

(57) ABSTRACT

[Object] To readily detect a position of a head of a user using an inexpensive sensor. [Solution] Change of the position of the head accompanied by viewpoint movement of the sitting user is accompanied by rotation movement of the head. Therefore, posture of the head of the user is obtained by integrating angular velocity detected by a gyro sensor worn on the head, and the posture of the head of the user is converted into a position of a head on a user coordinate system assuming that the head moves on a spherical surface having a radius of an arm length r around a waist position of the user. By adding the obtained change of the position in a head coordinate system to a position in a camera set at an application side which renders an image, motion parallax is presented.

### CROSS REFERENCE TO RELATED APPLICATIONS

This application is a U.S. National Phase of International Patent Application No. PCT/JP2015/051279 filed on Jan. 19, 2015, which claims priority benefit of Japanese Patent Application No. JP 2014-087849 filed in the Japan Patent Office on Apr. 22, 2014. Each of the above-referenced applications is hereby incorporated herein by reference in its entirety.

### TECHNICAL FIELD

The technology disclosed in this specification relates to a head position detecting apparatus and a head position detecting method for detecting a position of the head of a user, an image processing apparatus and an image processing method for processing an image following the position or posture of the head of the user, a display apparatus, and a computer program.

### BACKGROUND ART

An image display apparatus fixed at the head or a face portion of a user who observes an image, that is, a head-mounted display is known. The head-mounted display has, for example, an image display unit for each of right and left eyes and is configured to be able to control visual and auditory sense using headphones in combination. If the head-mounted display is configured to completely block the external world when worn on the head, virtual reality upon viewing is increased. Further, the head-mounted display can project different images to right and left eyes, and can present a 3D image by displaying images with parallax to the right and left eyes.

It is possible to observe an image obtained by cutting out a portion of a wide-angle image using the head-mounted display. The wide-angle image described here can include an image generated through 3D graphics such as a game as well as an image photographed by a camera.

For example, a proposal for the head-mounted display has been made (see, for example, Patent Literature 1 and Patent Literature 2), in which a head motion tracking apparatus formed with a gyro sensor, or the like, is attached to the head and is made to follow motion of the head of the user to allow the user to feel an image of the whole space at 360 degrees. By moving a display region in a wide-angle image so as to cancel out the motion of the head detected by the gyro sensor, it is possible to reproduce an image following the motion of the head and give the user experience as if he/she overlooked the whole space.

Further, when an object of augmented reality (AR) is disposed on a 3D graphics image such as an image photographed by a camera and a game, if motion parallax according to the position of the head is reproduced, the image becomes a natural image from which the user can perceive depth and stereoscopic effects, and in which a sense of immersion is increased. The motion parallax is a phenomenon that when the user observes an object with a depth, if the user moves relatively (in a horizontal direction) with respect to the object, change occurs in an image on the retina. Specifically, while an object farther than the observed object looks as if the object moved in the same direction as the moving direction, the observed object looks as if it moved in an opposite direction to the traveling direction. Adversely, an image in which motion parallax is not expressed becomes an image with unnatural depth and stereoscopic effects, which causes the user to get virtual reality (VR) sickness.

### CITATION LIST

### Patent Literature

Patent Literature 1: JP 9-106322A

Patent Literature 2: JP 2010-256534 A

### SUMMARY OF INVENTION

### Technical Problem

An object of the technology disclosed in this specification is to provide excellent head position detecting apparatus and head position detecting method which can easily detect a position of the head of a user.

A further object of the technology disclosed in this specification is to provide excellent image processing apparatus and image processing method, display apparatus and computer program, which can easily detect the position of the head of the user and present an image with motion parallax.

### Solution to Problem

The present application is based on the above-described problem, and the technology recited in to claim 1 is a head position detecting apparatus including: a detecting unit configured to detect posture of a head of a user; and a converting unit configured to convert the posture of the head into a position of a head in a user coordinate system.

According to the technology recited in claim 2 of the present application, the detecting unit of the head position detecting apparatus according to claim 1 includes a gyro sensor worn on the head of the user, and is configured to integrate angular velocity detected by the gyro sensor to calculate the posture of the head.

According to the technology recited in claim 3 of the present application, the detecting unit of the head position detecting apparatus according to claim 2 further includes an acceleration sensor, and is configured to compensate for drift with respect to a gravity direction of the posture obtained from the gyro sensor based on a gravity direction detected by the acceleration sensor.

According to the technology recited in claim 4 of the present application, the converting unit of the head position detecting apparatus according to claim 1 is configured to convert change of an angle of the head of the user into a position of a head seen from the user coordinate system in which an origin is set at a predetermined portion on a body of the user distant from the head by a predetermined arm length r.

According to the technology recited in claim 5 of the present application, the converting unit of the head position detecting apparatus according to claim 4 s configured to convert the change of the angle of the head into the position of the head seen from the user coordinate system assuming that the head of the user moves on a spherical surface fixed at a predetermined radius r from a predetermined center of rotation.

According to the technology recited in claim 6 of the present application, the converting unit of the head position detecting apparatus according to claim 4 is configured to convert the change of the angle of the head into the position of the head seen from the user coordinate system assuming that the head of the user moves on a spherical surface whose rotation center is an origin on the user coordinate system and which has a radius of the arm length r.

According to the technology recited in claim 7 of the present application, a waist position of the user is set at an origin of the user coordinate system. The converting unit of the head position detecting apparatus according to claim 4 is configured to convert the change of the angle of the head into the position of the head seen from the waist position of the user assuming that the head of the user moves on a spherical surface whose rotation center is the waist position of the user and which has a radius of the arm length r.

According to the technology recited in claim 8 of the present application, the converting unit of the head position detecting apparatus according to claim 4 is configured to convert the change of the angle of the head into the position of the head seen from the user coordinate system assuming that the head of the user moves on a spherical surface fixed at a radius r₁ from a center of rotation distant by a first arm length r₁ which is shorter than the arm length r.

According to the technology recited in claim 9 of the present application, a waist position of the user is set at an origin of the user coordinate system. The converting unit of the head position detecting apparatus according to claim 4 is configured to convert the change of the angle of the head into the position of the head seen from the waist position of the user assuming that the head of the user moves on a spherical surface fixed at a radius r₁ from a neck distant by a first arm length r₁ which is shorter than the arm length r.

According to the technology recited in claim 10 of the present application, the head position detecting apparatus according to claim 1, further includes: a second detecting unit configured to detect posture of a portion of an upper body other than the head of the user. The converting unit is configured to convert the posture of the head into the position of the head in the user coordinate system based on the posture of the head detected by the detecting unit and the posture of the portion of the upper body detected by the second detecting unit.

According to the technology recited in claim 11 of the present application, the converting unit of the head position detecting apparatus according to claim 4 is configured to adjust the arm length r according to an application to which the position of the head is to be applied.

According to the technology recited in claim 12 of the present application, the converting unit of the head position detecting apparatus according to claim 1 is configured to obtain the position of the head while limiting at least part of angular components of the posture of the head detected by the detecting unit according to an application to which the position of the head is to be applied.

According to the technology recited in claim 13 of the present application, the converting unit of the head position detecting apparatus according to claim 4 is configured to obtain a position of a head at each time by estimating the arm length r at each time.

According to the technology recited in claim 14 of the present application, the detecting unit of the head position detecting apparatus according to claim 13 includes a sensor configured to detect acceleration of the head of the user. The converting unit is configured to obtain the position of the head at each time by estimating the arm length r based on the acceleration detected at each time.

The technology recited in claim 15 of the present application is a head position detecting method including: a detecting step of detecting posture of a head of a user; and a converting step of converting the posture of the head into a position of a head in a user coordinate system.

The technology recited in claim 16 of the present application is an image processing apparatus including: a detecting unit configured to detect posture of a head of a user; a converting unit configured to convert the posture of the head into a position of a head in a user coordinate system; and a drawing processing unit configured to generate an image in which motion parallax corresponding to the position of the head is presented.

According to the technology recited in claim 17 of the present application, the drawing processing unit of the image processing apparatus according to claim 16 is configured to apply motion parallax to only values for which angular change of the head is within a predetermined value.

The technology recited in claim 18 of the present application is an image processing method including: a detecting step of detecting posture of a head of a user; a converting step of converting the posture of the head into a position of a head in a user coordinate system; and a drawing processing step of generating an image in which motion parallax corresponding to the position of the head is presented.

The technology recited in claim 19 of the present application is a display apparatus including: a detecting unit configured to detect posture of a head of a user; a converting unit configured to convert the posture of the head into a position of a head in a user coordinate system; a drawing processing unit configured to generate an image in which motion parallax corresponding to the position of the head is presented; and a display unit.

The technology recited in claim 20 of the present application is a computer program described in a computer readable form so as to cause a computer to function as: a converting unit configured to convert posture of a head detected by a detecting unit worn on the head of a user into a position of a head in a user coordinate system; and a drawing processing unit configured to generate an image in which motion parallax corresponding to the position of the head is presented.

The computer program according to claim 20 of the present application defines a computer program described in a computer readable form so as to realize predetermined processing on a computer. In other words, by installing the computer program according to claim 20 of the present application in the computer, cooperative action is exerted on the computer, so that it is possible to provide the same operational effects as those of the image processing apparatus according to claim 16 of the present application.

### Advantageous Effects of Invention

According to the technology disclosed in this specification, it is possible to provide excellent head position detecting apparatus and head position detecting method which can easily detect a position of the head of a user using an inexpensive sensor.

Further, according to the technology disclosed in this specification, it is possible to provide excellent image processing apparatus and image processing method, display apparatus and computer program which can detect the position of the head of the user using an inexpensive sensor and present an image with motion parallax.

Note that the advantageous effects described in this specification are merely for the sake of example, and the advantageous effects of the present invention are not limited thereto. Furthermore, in some cases the present invention may also exhibit additional advantageous effects other than the advantageous effects given above.

Further objectives, features, and advantages of the technology disclosed in this specification will be clarified by a more detailed description based on the exemplary embodiments discussed hereinafter and the attached drawings.

### BRIEF DESCRIPTION OF DRAWINGS

FIG. 1 is a diagram schematically illustrating an example configuration of an image display system 100 applying technology disclosed in this specification.

FIG. 2 is a diagram schematically illustrating a modified example of the image display system 100.

FIG. 3 is a diagram (perspective view) illustrating an exterior configuration of a display apparatus 400 according to an embodiment of the technology disclosed in this specification.

FIG. 4 is a diagram (left side view) illustrating the exterior configuration of the display apparatus 400 according to an embodiment of the technology disclosed in this specification.

FIG. 5 is a diagram illustrating relationship among coordinate systems used upon detection of a posture angle of the head and calculation of a position of the head from posture of the head according to an embodiment of the technology disclosed in this specification.

FIG. 6A is a diagram illustrating a position of the head obtained based on the posture of a sitting user (when the user takes substantially erect posture) and the posture of the head of the user according to an embodiment of the technology disclosed in this specification.

FIG. 6B is a diagram illustrating the position of the head obtained based on the posture of the sitting user (when the upper body rolls in a left direction around the waist position) and the posture of the head of the user according to an embodiment of the technology disclosed in this specification.

FIG. 6C is a diagram illustrating the position of the head obtained based on the posture of the sitting user (when the upper body tilts forward around the waist position) and the posture of the head of the user according to an embodiment of the technology disclosed in this specification.

FIG. 7A is a diagram illustrating an observed image of a plurality of balls arranged in a depth direction when the sitting user sees a front side with the substantially erect posture according to an embodiment of the technology disclosed in this specification.

FIG. 7B is a diagram illustrating an image observed when the sitting user sees a plurality of balls arranged in the depth direction from the side while the user tilts his/her upper body leftward (rolls the upper body around the waist position) according to an embodiment of the technology disclosed in this specification.

FIG. 8A is a diagram illustrating an observed image of a 3D VR image when the sitting user sees a front side with the substantially erect posture according to an embodiment of the technology disclosed in this specification.

FIG. 8B is a diagram illustrating an image observed when the sitting user sees the VR image which is the same as that of FIG. 8A from the side while the user tilts his/her upper body leftward according to an embodiment of the technology disclosed in this specification.

FIG. 9 is a diagram illustrating a model in which the upper body of the sitting user rotates around the waist position (when the user tilts rightward) according to an embodiment of the technology disclosed in this specification.

FIG. 10 is a diagram illustrating a model in which the upper body of the sitting user rotates around the waist position (when the user tilts forward) according to an embodiment of the technology disclosed in this specification.

FIG. 11 is a diagram illustrating a model in which the head of the sitting user rotates around the neck (when the user tilts rightward) according to an embodiment of the technology disclosed in this specification.

FIG. 12 is a diagram illustrating a model in which the head of the sitting user rotates around the neck (when the user tilts forward) according to an embodiment of the technology disclosed in this specification.

FIG. 13 is a diagram for explaining an error in a method for obtaining the position of the head from change of an angle of the head of the user according to an embodiment of the technology disclosed in this specification.

FIG. 14 is a diagram illustrating a model in which the head rotates around the neck while the upper body of the sitting user rotates around the waist according to an embodiment of the technology disclosed in this specification.

FIG. 15 is a diagram illustrating a game image when a player passes through a right-hand curve according to an embodiment of the technology disclosed in this specification.

FIG. 16A is a diagram illustrating operation in which the upper body of the sitting user rolls leftward around the waist position according to an embodiment of the present disclosure.

FIG. 16B is a diagram illustrating operation in which only the head rolls leftward around the root of the neck while the body of the sitting user remains substantially still according to an embodiment of the technology disclosed in this specification.

FIG. 16C is a diagram illustrating operation in which only the head tilts forward around the root of the neck while the body of the sitting user remains substantially still according to an embodiment of the technology disclosed in this specification.

FIG. 16D is a diagram illustrating operation in which the upper body of the sitting user tilts forward around the waist position according to an embodiment of the present disclosure.

FIG. 17 is a diagram illustrating an example where a user coordinate system XYZ is expressed with a polar coordinate system rθφ.

FIG. 18 is a diagram illustrating an arm length r and a centripetal force applied to the head when the head of the user rotates around the waist according to an embodiment of the technology disclosed in this specification.

FIG. 19 is a diagram illustrating the arm length r and the centripetal force applied to the head when the head of the user rotates around the neck according to an embodiment of the technology disclosed in this specification.

### DESCRIPTION OF EMBODIMENT

An embodiment of the technology disclosed in this specification will be described in detail below with reference to the drawings.

When an object of AR is put on a 3D graphics image such as a game, an image photographed by a camera, or the like, displayed on a display such as a head-mounted display, the image becomes a natural image from which a user can perceive depth and stereoscopic effects, and in which a sense of immersion is increased. Adversely, an image in which motion parallax is not expressed becomes an image with unnatural depth and stereoscopic effects, which causes the user to get VR sickness.

When an image in which motion parallax is reproduced is presented with a head-mounted display, or the like, it is necessary to detect a position and posture of the head of the user (that is, a wearer of the head-mounted display). Further, when it is assumed that an inexpensive head-mounted display which is light and which can be easily carried will be spread in the future, it is desirable to enable detection of the position and the posture of the head using an inexpensive sensor to present motion parallax.

The posture of the head of the user can be detected using, for example, a gyroscope. Meanwhile, detection of the position of the head, typically, requires an expensive sensor. If the position information of the head cannot be utilized, it is only possible to rotate the object of AR according to the posture of the head, and it is not possible to rotate the object according to parallel movement of the head. Therefore, it is not possible to reproduce motion parallax (it is not possible to make an object farther than the observed object look as if the object changed the position in the same direction as the moving direction and make the observed object look as if the observed object changed the position in an opposite direction to the traveling direction.)

For example, a method is known in this field, for detecting a position of an object existing within an environment using an infrared camera, a depth camera, an ultrasonic sensor, a magnetic sensor, or the like, provided in the environment. While such a method is useful to detect a position of the head-mounted display, it is necessary to provide a sensor outside the head-mounted display (in other words, at a location distant from the head-mounted display), which tends to increase the price. Further, while there is no problem if the head-mounted display is always used in the same room, if the head-mounted display is taken outside and utilized at a location to which the head-mounted display is taken out, it is necessary to provide a sensor in an environment, which will impede utilization.

Further, there is also a possible method for detecting an own position by performing image processing on an image of a surrounding environment photographed by a camera mounted on the head-mounted display. For example, in a method in which a marker is provided in an environment and a position of the marker on the photographed image is detected, it is necessary to provide the marker at the environment side. Further, by tracking characteristic points such as an edge on the photographed image, it is possible to detect the own position without providing the marker. While the latter is useful because it is possible to realize detection of the position only using a sensor within the head-mounted display, arithmetic processing for performing image processing and the camera become factors for increasing the cost. Further, the latter is affected by environment-dependent influence, for example, it is difficult to track and utilize characteristic points such as an edge in a darkish room or an environment with no texture like a white wall. In addition, when a camera which can perform photographing at high speed is not used, it is difficult to track quick motion of the head.

Further, it is also possible to mount a gyro sensor or an acceleration sensor as applied in an inertia navigation system at the head-mounted display to detect the position of the head. Specifically, it is possible to obtain the position by performing second order integration on motion acceleration obtained by subtracting gravity acceleration components from acceleration components detected by the acceleration sensor. This method is useful because the position can be detected only with a sensor within the head-mounted display. However, there is a problem that drift occurs at the position over time due to influence of an integration error. For example, if a fixed bias a_{b} occurs at the motion acceleration a obtained by subtracting the gravity acceleration from the output of the acceleration sensor, a drift error x at the position at time t is as expressed in the following equation (1). That is, the drift error x increases in proportion to a square of time t.

$$\begin{matrix}[ Math . 1 ] & \\ x = \frac{1}{2} {a}_{b} {t}^{2} & ( 1 )\end{matrix}$$

It is important to remove the drift error x by always evaluating fixed bias a_{b} from the position detection result. However, in the case of an inexpensive acceleration sensor as mounted at the head-mounted display, it is not easy to suppress the drift error x occurring through the second order integration. Further, in order to detect minute motion of the head of the wearer of the head-mounted display, it is necessary to separate small motion acceleration from the output of the acceleration sensor from noise components or the gravity acceleration components. This is not easily realized with an acceleration sensor which is susceptible to noise. To realize this, it is necessary to estimate posture with high accuracy or calibrate the acceleration sensor regularly and accurately. To remove a drift error, while there is a possible method in which a position detection sensor is used in combination, the above-described problem occurs in the existing position detecting technology.

In short, it is difficult to detect the position and the posture of the head only using an inexpensive sensor mounted at the head-mounted display and present motion parallax.

Meanwhile, while it is difficult to detect the position of the head when the wearer of the head-mounted display walks around, there is a use case where presentation of motion parallax occurring by minute movement of the head when the wearer sits down is sufficient. As a specific example, there is a case where a 3D graphics image of a racing game is viewed using the head-mounted display.

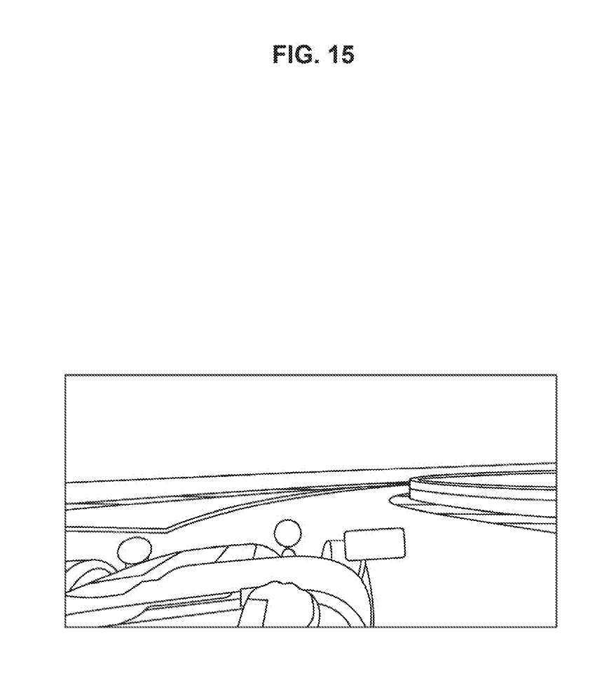

FIG. 15 illustrates a game image when a player passes a right-hand curve. The illustrated game image corresponds to sight of a driver's seat. In actual driving of a car, typically, the driver tries to confirm the road behind a blind curve by tilting his/her body leftward. In a normal game, while it is possible to present an image in which a viewpoint of a camera of the game is changed from the posture of a car body, it is not possible to reflect motion of the head of the player of the game to the game. However, if it is possible to detect change of the position of the head of the player of the game who sits down, it is possible to present an image behind a blind curve according to the motion of the head.

Further, there is a use case of other games or a use case other than games in which the user sits down and views 3D graphics other than a racing game. In most cases of such a use case, the motion of the head of the sitting user is minute and presentation of motion parallax occurring by minute movement of the head is sufficient.

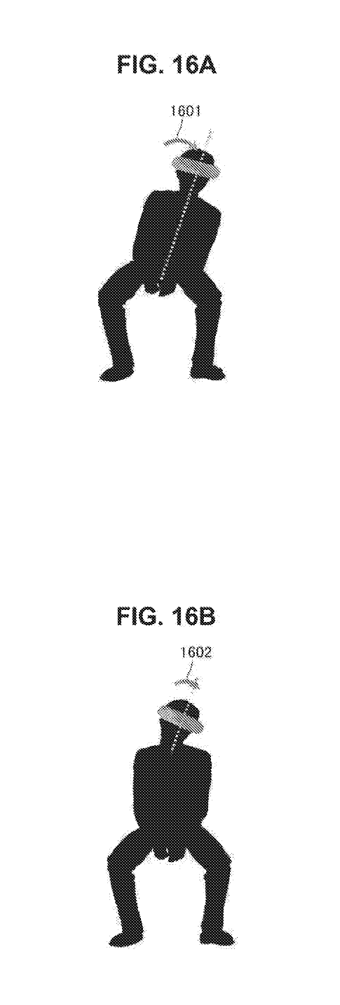

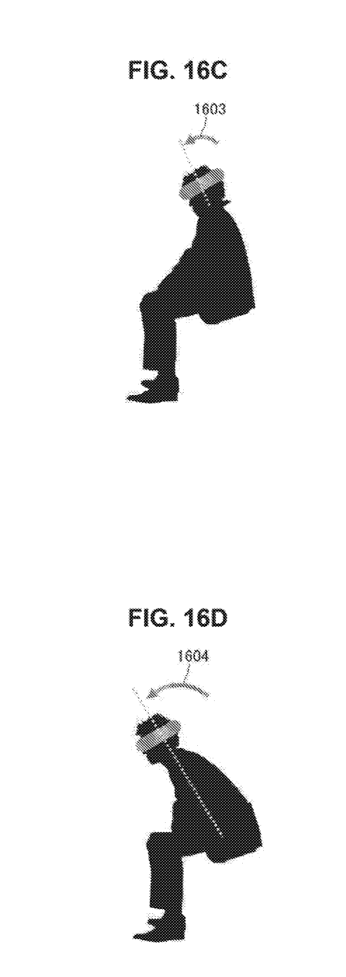

FIG. 16A to FIG. 16D illustrate operation including movement (change of the position) of the head accompanied by movement of the viewpoint of the user (such as the wearer of the head-mounted display) who sits down. FIG. 16A illustrates an aspect where the upper body of the sitting user rolls leftward around the waist position, and the head moves as indicated with a reference numeral 1601. FIG. 16B illustrates an aspect where only the head rolls leftward around the root of the neck while the body of the sitting user remains substantially still, and the head moves as indicated with a reference numeral 1602. FIG. 16C illustrates an aspect where only the head tilts forward around the root of the neck while the body of the sitting user remains substantially still, and the head moves as indicated with a reference numeral 1603. FIG. 16D illustrates an aspect where the upper body of the sitting user tilts forward around the waist position, and the head moves as indicated with a reference numeral 1604. In any motion of the sitting user as illustrated in FIG. 16A to FIG. 16D, the motion 1601 to 1604 of the head of the user is minute, and it can be considered that only presentation of motion parallax occurring by the minute motion 1601 to 1604 of the head is sufficient. Note that because yaw rotation (pan) of the head or the upper body of the sitting user is not accompanied by movement of the head, illustration will be omitted.

As can be seen from FIG. 16, the motion of the head of the sitting user is minute, and change of the position of the head accompanied by movement of the viewpoint is accompanied by rotation movement of the head. Therefore, by detecting the rotation movement of the head using an inexpensive posture/angular sensor such as a gyro sensor and by deriving change of the position of the head based on the detection result, it is possible to present simplified motion parallax.

In the technology disclosed in this specification, rotation movement of the head is detected from the posture/angular sensor such as a gyro sensor provided at the head of the user (such as the wearer of the head-mounted display) of the image, and motion parallax by minute motion of the head is presented based on the detection result in a simplified manner. In the technology disclosed in this specification, while an accurate position of the head cannot be detected, in a use case such as when the user sits down in which movement of the head is accompanied by the rotation movement, it is possible to obtain the position of the head from the rotation movement of the head in a simplified manner, and it is possible to present motion parallax sufficiently effectively.

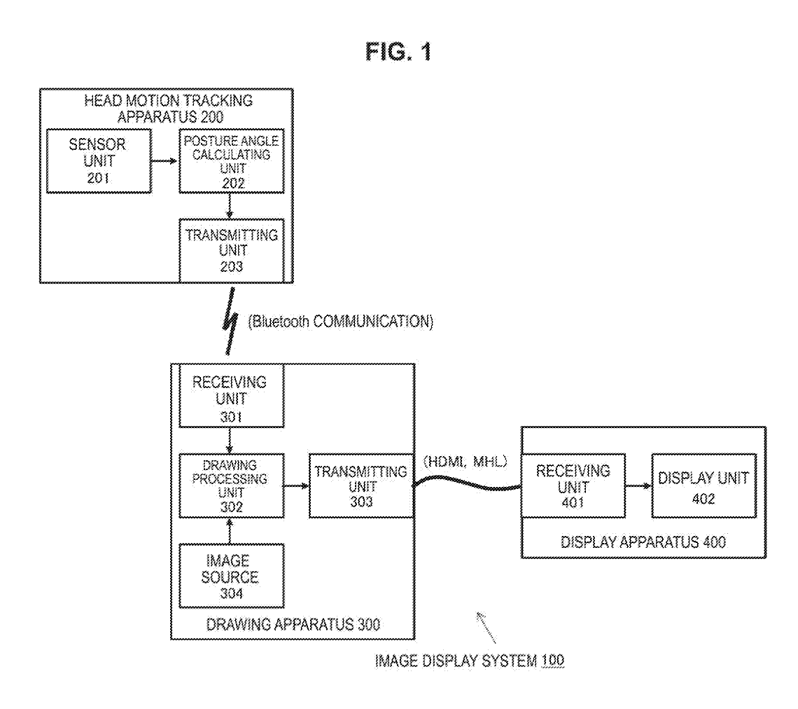

FIG. 1 schematically illustrates a configuration example of the image display system 100 to which the technology disclosed in this specification is applied. The illustrated image display system 100 is configured with a head motion tracking apparatus 200, a drawing apparatus 300 and a display apparatus 400.

The head motion tracking apparatus 200 is used by being worn on the head of the user who observes an image displayed by the display apparatus 400, and outputs posture information of the head of the user to the drawing apparatus 300 at a predetermined transmission cycle. In the illustrated example, the head motion tracking apparatus 200 includes a sensor unit 201, a posture angle calculating unit 202, and a transmitting unit 203 which transmits a calculation result of the posture angle calculating unit 202 to the drawing apparatus 300.

The sensor unit 201 is configured with sensor elements which detect posture of the head of the user who wears the head motion tracking apparatus 200. The sensor unit 201 basically includes a gyro sensor mounted on the head of the user. The gyro sensor is inexpensive and requires extremely low processing load for processing a detection signal of the sensor at the posture angle calculating unit 202 and can be easily mounted. Compared to other sensors such as a camera, the gyro sensor has an advantage that it has a favorable S/N ratio. Further, because a movement amount of the head is obtained from the posture angle detected by the gyro sensor which has a high sampling rate, it is possible to contribute to presentation of extremely smooth motion parallax ranging from low-speed head movement to high-speed head movement.

When the position is detected using the gyro sensor, there is a problem of drift with respect to a gravity direction as described above. Therefore, it is also possible to use an acceleration sensor in combination with a gyro sensor as the sensor unit 201. It is possible to easily compensate for the drift with respect to the gravity direction of the posture obtained from the gyro sensor from the gravity direction detected by the acceleration sensor, and also possible to suppress drift of movement of the viewpoint over time. Of course, when a gyro sensor which can ignore a drift amount is utilized, it is not necessary to use the acceleration sensor in combination. Further, in order to compensate for drift of the posture around the yaw axis of the head, it is also possible to use a magnetic sensor in combination as necessary.

It is necessary to perform calibration for a sensor which is affected by temperature characteristics, or the like. In this embodiment, special calibration is not required other than offset processing of the gyro sensor. The offset calibration of the gyro sensor can be easily executed by, for example, subtracting an average value of the output of the gyro sensor in a still state.

Note that the sensor unit 201 may be configured to detect change of the posture of the head using sensor elements other than the gyro sensor. For example, it is also possible to detect the posture from the gravity acceleration direction applied to the acceleration sensor. Alternatively, it is also possible to detect change of the posture of the head by performing image processing on a surrounding image photographed by a camera worn on the head of the user (or mounted at the head-mounted display).

The posture angle calculating unit 202 calculates a posture angle of the head of the user based on the detection result by the sensor unit 201. Specifically, the posture angle calculating unit 202 integrates angular velocity obtained from the gyro sensor to calculate the posture of the head. In the image display system 100 according to this embodiment, it is also possible to handle the posture information of the head as a quaternion. The quaternion is composed of a rotation axis (vector) and a rotation angle (scalar). Alternatively, it is also possible to describe the posture information of the head in other forms such as an Euler angle and polar coordinates.

Further, the posture angle calculating unit 202 calculates a posture angle and then further calculates a movement amount of the head from the posture angle using a method which will be described later. The transmitting unit 203 then transmits the position information of the head obtained at the posture angle calculating unit 202 to the drawing apparatus 300. Alternatively, the posture angle calculating unit 202 may only calculate the posture angle, the transmitting unit 203 may transmit the posture information of the head to the drawing apparatus 300, and the drawing apparatus 300 side may convert the posture information of the head into the head position information.

In the illustrated image display system 100, it is assumed that the head motion tracking apparatus 200 is connected to the drawing apparatus 300 through wireless communication such as Bluetooth (registered trademark) communication. Of course, the head motion tracking apparatus 200 may be connected to the drawing apparatus 300 via a high-speed wired interface such as a universal serial bus (USB) instead of the wireless communication.

The drawing apparatus 300 performs rendering processing on an image to be displayed at the display apparatus 400. While the drawing apparatus 300 is configured as, for example, a terminal employing Android (registered trademark) such as a smartphone and a tablet, a personal computer, or a game machine, the drawing apparatus 300 is not limited to these apparatuses. Further, the drawing apparatus 300 may be a server apparatus on the Internet. The head motion tracking apparatus 200 transmits the head posture/position information of the user to a server as the drawing apparatus 300, and, when the drawing apparatus 300 generates a moving image stream corresponding to the received head posture/position information, the drawing apparatus 300 transmits the moving image stream to the display apparatus 400.

In the illustrated example, the drawing apparatus 300 includes a receiving unit 301 configured to receive position information of the head of the user from the head motion tracking apparatus 200, a drawing processing unit 302 configured to perform rendering processing on an image, a transmitting unit 302 configured to transmit the rendered image to the display apparatus 400, and an image source 304 which is a supply source of image data.

The receiving unit 301 receives the position information or the posture information of the head of the user from the head motion tracking apparatus 200 through Bluetooth (registered trademark) communication, or the like. The posture information is, for example, expressed in a form of a rotation matrix or a quaternion.

The image source 304 is formed with, for example, a storage apparatus such as a hard disc drive (HDD) and a solid state drive (SSD) which records image content, a media reproducing apparatus which reproduces recording media such as Blu-ray (registered trademark), a broadcasting tuner which tunes a channel and receives a digital broadcasting signal, and a communication interface which receives a moving image stream from a streaming server, or the like, provided on the Internet.

The drawing processing unit 302 executes a game for generating 3D graphics or an application for displaying an image photographed by a camera to render an image to be displayed at the display apparatus 400 side from the image data of the image source 304. In this embodiment, the drawing processing unit 302 renders an image in which motion parallax corresponding to the position of the head is presented from an original image supplied from the image source 304 based on the position information of the head of the user received at the receiving unit 301. Note that when the posture information of the head is transmitted from the head motion tracking apparatus 200 instead of the position information of the head of the user being transmitted, the drawing processing unit 302 performs processing of converting the posture information of the head into the position information.

The drawing apparatus 300 is connected to the display apparatus 400 using a cable such as, for example, a high definition multimedia interface (HDMI) (registered trademark) and a mobile high-definition link (MHL). Alternatively, the drawing apparatus 300 may be connected to the display apparatus 400 through wireless communication such as wireless HD and Miracast. The transmitting unit 303 transmits the image data rendered at the drawing processing unit 302 to the display apparatus 400 using any communication path without compressing the data.

The display apparatus 400 includes a receiving unit 401 configured to receive an image from the drawing apparatus 300 and a display unit 402 configured to display the received image. The display apparatus 400 is, for example, configured as a head-mounted display fixed at the head or the face portion of the user who observes the image. Alternatively, the display apparatus 400 may be a normal TV monitor, a large-screen display or a projection display apparatus.

The receiving unit 401 receives uncompressed image data from the drawing apparatus 300 through a communication path such as, for example, HDMI (registered trademark) and MHL. The display unit 402 displays the received image data on a screen.

When the display apparatus 400 is configured as the head-mounted display, for example, the display unit 402 includes left and right screens respectively fixed at left and right eyes of the user to display an image for left eye and an image for right eye. The screen of the display unit 402 is configured with, for example, a display panel such as a micro display such as an organic electro-luminescence (EL) element and a liquid crystal display or a laser scanning type display such as a retinal direct drawing display. Further, the display unit 402 includes a virtual image optical unit configured to enlarge and project a display image of the display unit 402 and form an enlarged virtual image formed with a predetermined angle of field on pupils of the user.

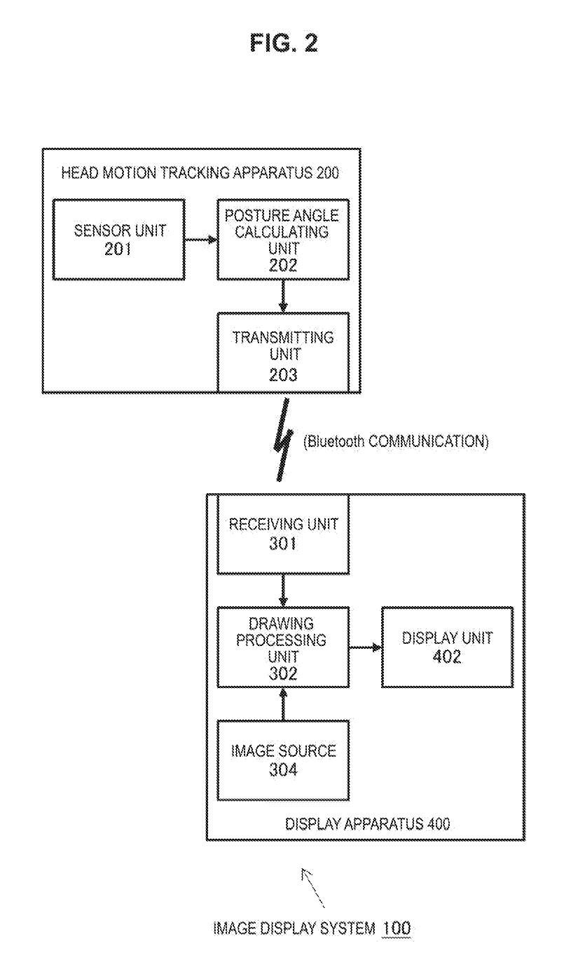

FIG. 2 schematically illustrates a modified example of the image display system 100. While, in the example illustrated in FIG. 1, the image display system 100 is configured with three independent apparatuses including the head motion tracking apparatus 200, the drawing apparatus 300 and the display apparatus 400, in the example illustrated in FIG. 2, functions of the drawing apparatus 300 are mounted within the display apparatus 400. The same reference numerals are assigned to components which are the same as those in FIG. 1. Explanation of each component will be omitted here. As illustrated in FIG. 1 and FIG. 2, if the head motion tracking apparatus 200 is configured as an optional product externally attached to the display apparatus 400, it is possible to make the display apparatus 400 smaller, lighter and inexpensive.

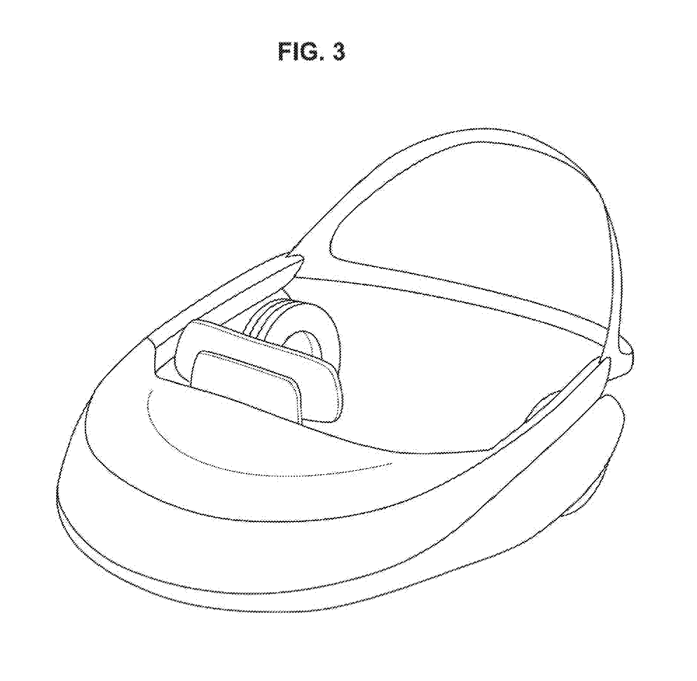

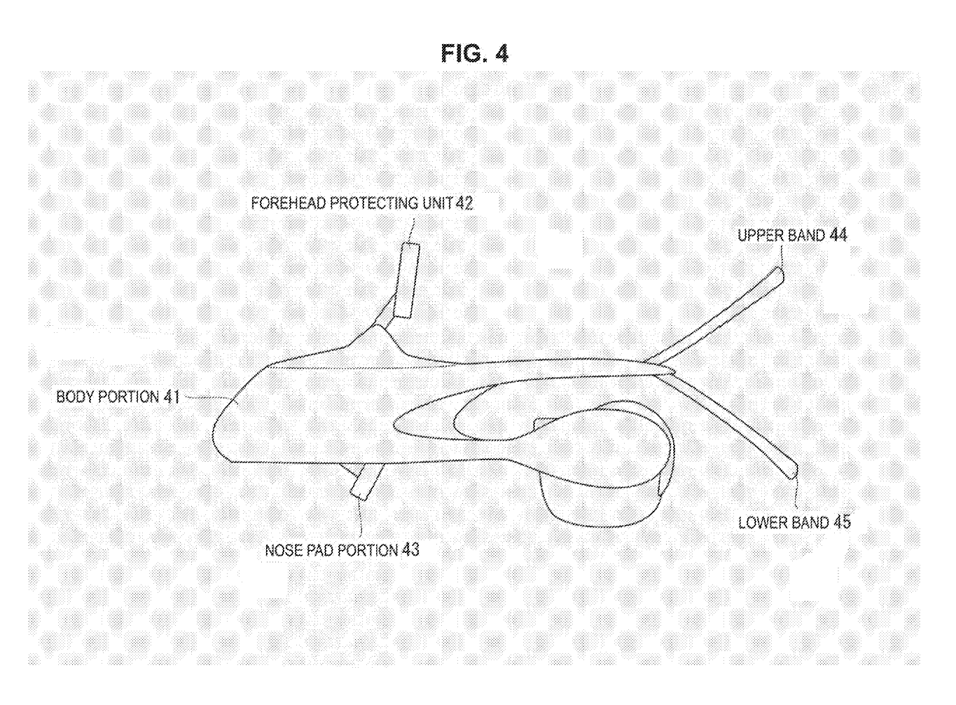

FIG. 3 and FIG. 4 illustrate exterior configurations of the display apparatus 400. In the illustrated example, the display apparatus 400 is configured as a head-mounted display which is used while being fixed at the head or the face portion of the user who observes an image. However, FIG. 3 is a perspective view of the head-mounted display, while FIG. 4 is a left side view of the head-mounted display.

The illustrated display apparatus 400 is a head-mounted display which has a hat shape or a belt-like configuration covering all the circumferences of the head, and which can be worn while reducing load on the user by distributing weight of the apparatus to the whole of the head.

The display apparatus 400 is formed with a body portion 41 including most parts including a display system, a forehead protecting portion 42 projecting from an upper face of the body portion 41, a head band diverging into an upper band 44 and a lower band 45, and left and right headphones. Within the body portion 41, a display unit and a circuit board are held. Further, a nose pad portion 43 to follow the back of the nose is provided below the body portion 41.

When the user wears the display apparatus 400 on the head, the forehead protecting portion 42 abuts on the forehead of the user, while the upper band 44 and the lower band 45 of the head band respectively abut on a posterior portion of the head. That is, the display apparatus 400 is worn on the head of the user by being supported at three points of the forehead protecting portion 42, the upper band 44 and the lower band 45. Therefore, the configuration of the display apparatus 400 is different from a configuration of normal glasses whose weight is mainly supported at the nose pad portion, and the display apparatus 400 can be worn while load on the user is reduced by distributing the weight to the whole of the head. While the illustrated display apparatus 400 also includes the nose pad potion 43, this nose pad portion 43 only contributes to auxiliary support. Further, by fastening the forehead protecting portion 42 with the head band, it is possible to support motion in the rotation direction so that the display apparatus 400 does not rotate at the head of the user who wears the display apparatus 400.

The head motion tracking apparatus 200 can be also mounted within the body portion 41 of the display apparatus 400 which is configured as the head-mounted display. However, in this embodiment, in order to make the display apparatus 400 smaller, lighter and inexpensive, the head motion tracking apparatus 200 is provided as an optional product externally attached to the display apparatus 400. The head motion tracking apparatus 200 is, for example, used by being attached to any location of the upper band 44, the lower band 45 and the forehead protecting portion 42 of the display apparatus 400 as an accessory.

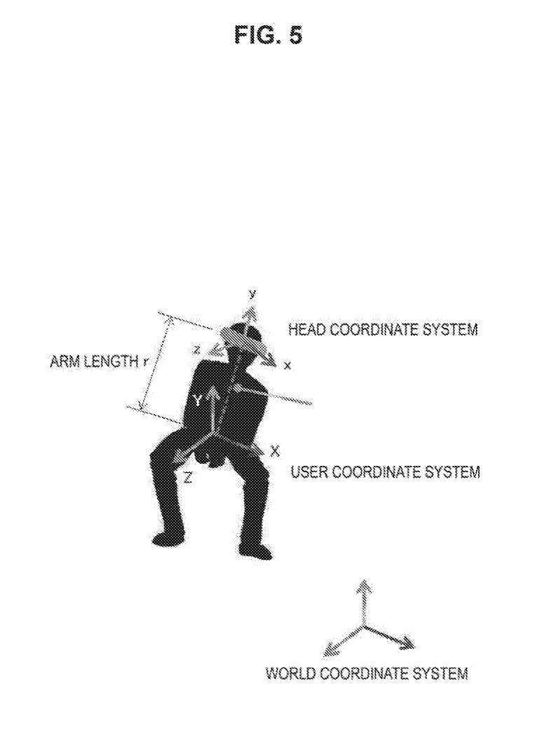

As described above, the posture angle calculating unit 202 integrates the angular velocity obtained from the sensor unit 201 (hereinafter, simply referred to as a “gyro sensor”) to calculate the posture of the head. FIG. 5 illustrates relationship among coordinate systems used when the posture angle of the head is detected and the position of the head is calculated from the posture of the head in this embodiment. As illustrated in FIG. 5, a coordinate system in which the waist position of the user is set as an origin is set with respect to a world coordinate system while a front direction of the user is set as a Z axis, a gravity direction is set as a Y axis, and a direction orthogonal to the Z axis and the Y axis is set as an X axis. In the following description, this XYZ coordinate system is referred to as a “user coordinate system”. With respect to this user coordinate system, a head coordinate system xyz is set at a position distant from the origin of the user coordinate system by an arm length r.

The position of the head coordinate system is defined as a position which can be obtained by rotating the posture of the head obtained from the gyro sensor worn on the head of the user with respect to the arm length r. Here, the posture of the head is defined as posture which can be obtained by integrating the angular velocity obtained from the gyro sensor. Even when the user rotates around the y axis of the head coordinate system, the position of the head does not change. On the other hand, when the head of the user rotates around the x axis or the z axis, the position of the head changes. When the position is calculated by performing second order integration on the motion acceleration detected at the acceleration sensor, while there is a problem that drift occurs at the position over time, such a problem does not occur in the position calculating method according to this embodiment.

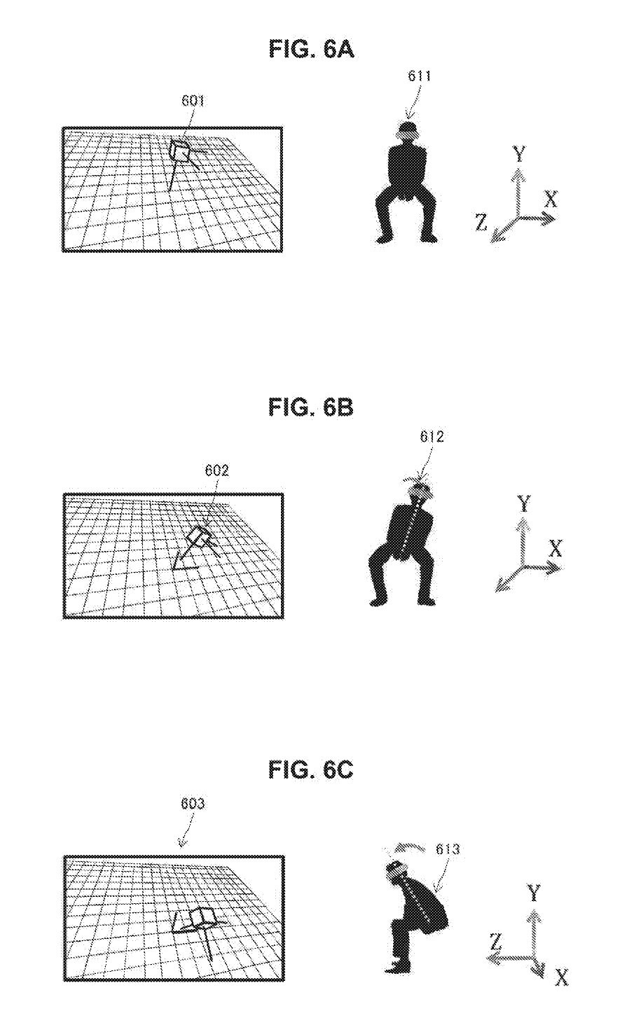

FIG. 6A to FIG. 6C illustrate the posture of the sitting user in a right part and the position of the head calculated from the posture of the head in a left part. It is possible to obtain the posture of the head of the user by integrating the angular velocity detected by the gyro sensor worn on the head. It is possible to convert the posture of the head of the user into the position of the head on the user coordinate system assuming that the head of the sitting user moves on a spherical surface having a radius of the arm length r around the waist position of the user. The right part of FIG. 6A illustrates an aspect where the sitting user 611 takes substantially erect posture, while the left part of FIG. 6A illustrates the head position 601 converted from the posture of the head at that time. Further, the right part of FIG. 6B illustrates an aspect where the upper body of the sitting user 612 rolls around the waist position in a left direction, while the left part of FIG. 6B illustrates the head position 602 at that time. Further, the right part of FIG. 6C illustrates an aspect where the upper body of the sitting user 613 tilts forward around the waist position, while the left part of FIG. 6C illustrates the head potion 603 at that time. By adding the change of the position of the head coordinate system obtained in this manner to a position in a camera set at the application side which renders the image, it is possible to present motion parallax.

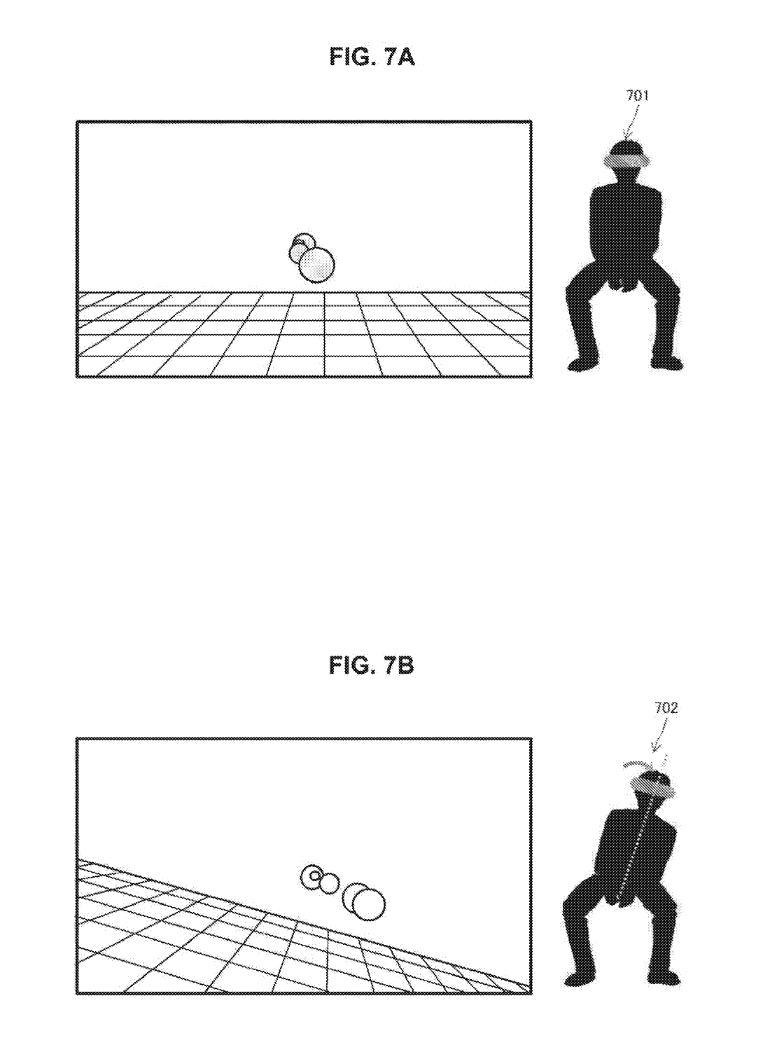

FIG. 7A illustrates an observed image of a plurality of balls arranged in a depth direction when the sitting user 701 sees a front side with the substantially erect posture. In such a case, because the plurality of balls overlap with each other in the depth direction, balls arranged at the back side are hidden by balls arranged at the front side and cannot be seen. Further, FIG. 7B illustrates an image observed when the sitting user 702 sees a plurality of balls arranged in the depth direction from the side while the user tilts his/her upper body leftward (rolls the upper body around the waist position). As illustrated in FIG. 7B, the user 702 can see the side (left side) of the balls at the back side which overlap with the balls at the front side in the depth direction by tilting his/her upper body leftward, and motion parallax is presented. While distant balls look as if they changed their positions in the same direction as the moving direction of the head, near balls look as if they changed their positions in an opposite direction to a traveling direction of the head. Therefore, the image becomes a natural image from which the user can perceive depth and stereoscopic effects, and in which a sense of immersion is increased. Note that in FIG. 7B, the ground looks as if it rotated because the image is an image for the head-mounted display. That is, because the ground in the image rotates in a direction which cancels out tilt of the head of the user who wears the head-mounted display, the image in the ground looks as if it did not rotate from the user.

On the other hand, when motion parallax is not presented, even if the user tilts his/her upper body leftward, because the image becomes an image in which a VR image illustrated in FIG. 7A simply rotates in accordance with the posture of the head, that is, in which positions of the plurality of balls arranged in the depth direction integrally change in the same direction, the image becomes an image with unnatural depth and stereoscopic effects, which causes the user to get VR sickness.

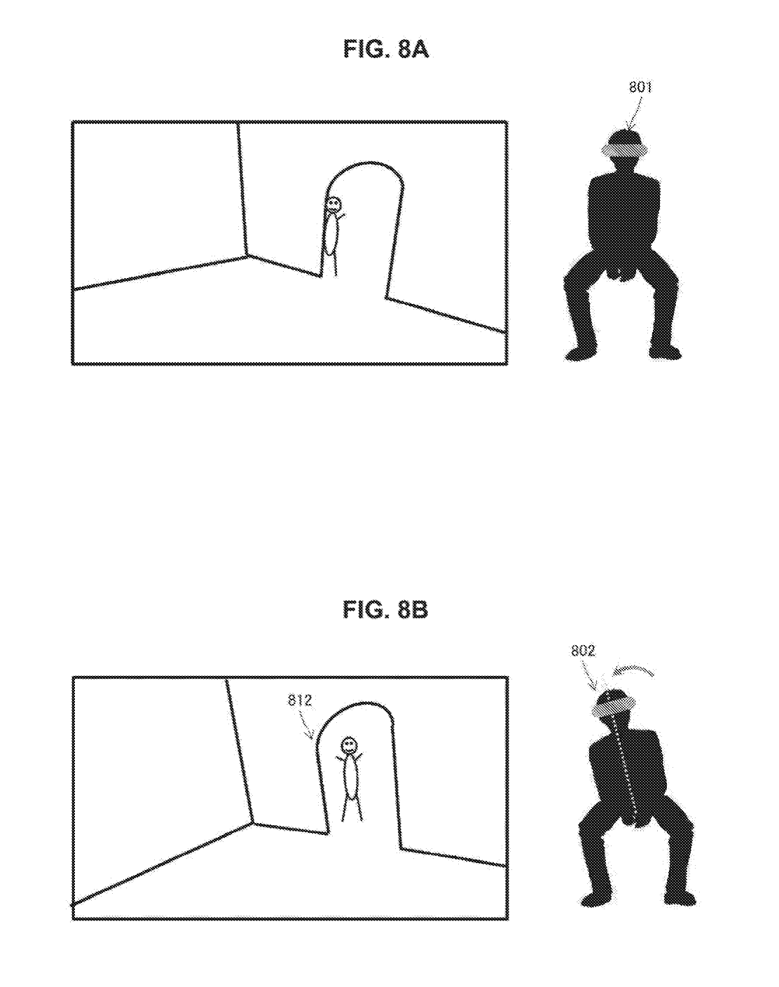

FIG. 8A illustrates an observed image of a 3D VR image when the sitting user 801 sees a front side with substantially erect posture. Further, FIG. 8B illustrates an image observed when the sitting user 802 sees the same VR image as that in FIG. 8A from the side while the user 802 tilts his/her upper body rightward (rolls the upper body around the waist position). As illustrated in FIG. 8B, in the VR image in which motion parallax is presented when the head position of the user 802 moves in a right direction, the scenery outside a door 812 of the room moves to a right side. While a front portion of the room looks as if it changed the position in an opposite direction to the traveling direction, the scenery outside the door looks as if it changed the position in the same direction as the moving direction. That is, the user 802 can see the scenery outside which is hidden by the left side of the door 812 by tilting his/her upper body rightward. Therefore, the image becomes a natural image from which the user can perceive depth and stereoscopic effects, and in which a sense of immersion is increased.

On the other hand, when motion parallax is not presented, even if the user tilts his/her upper body rightward, because the image becomes an image in which the VR image illustrated in FIG. 8A simply rotates in accordance with the posture of the head, that is, the positions of the room inside and the scenery outside the door integrally change, the image becomes an image with unnatural depth and stereoscopic effects, which causes the user to get VR sickness.

As illustrated in FIG. 7A and FIG. 8B, because it is possible to present motion parallax in accordance with change of the position of the head based on the posture information of the head of the user, for example, in a game of first person shooting (FPS), application is possible such that a player fends off an attack from an enemy by moving the body (upper body).

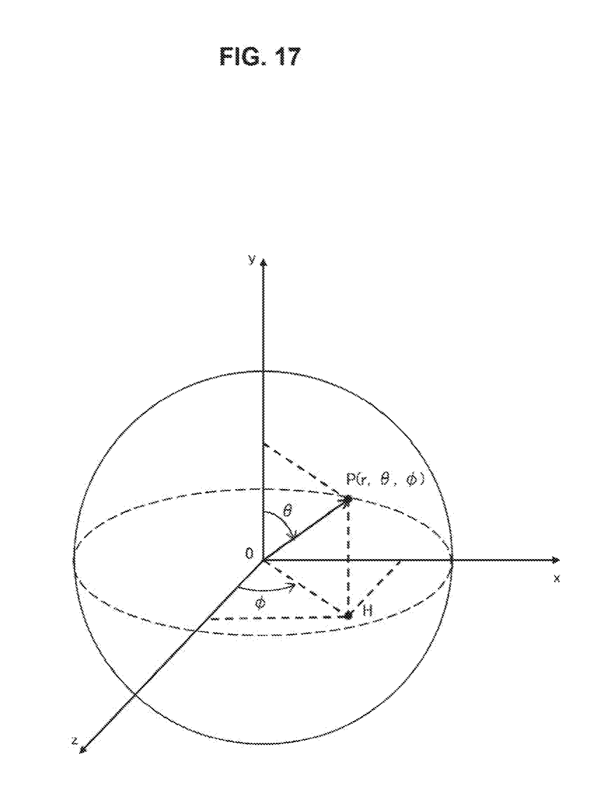

A method for obtaining the position of the head based on the posture information of the head regarding the sitting user will be described in detail below. However, the method will be described by expressing the user coordinate system XYZ with the polar coordinate system rθφ (see FIG. 17). It is assumed that the angular change θ and φ of the head can be obtained at the posture angle calculating unit 202, and processing of obtaining the position of the head based on the angular change θ and φ of the head is executed within the drawing processing unit 302.

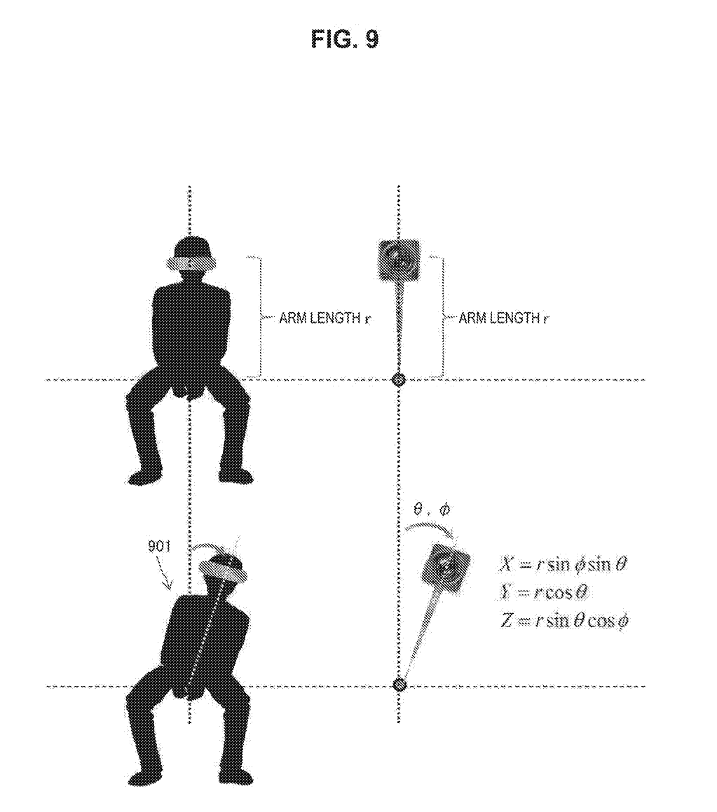

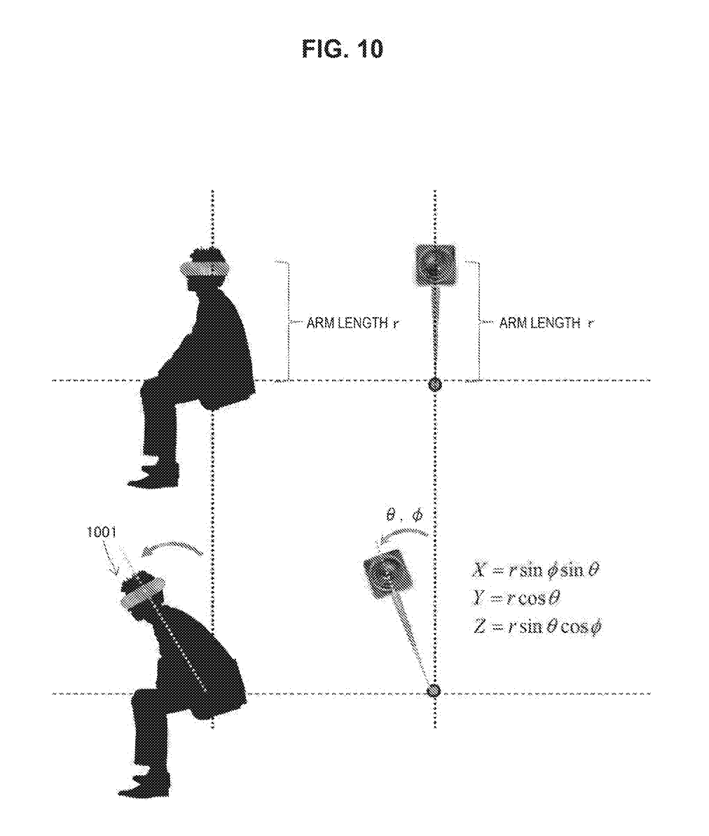

First, as illustrated in FIG. 9 and FIG. 10, a model in which the upper body of the sitting user rotates around the waist position will be considered. However, FIG. 9 illustrates a case where the upper body of the sitting user 901 tilts leftward (to a right side on the paper) around the waist position, while FIG. 10 illustrates a case where the upper body of the sitting user 1001 tilts forward around the waist position.

In FIG. 9 and FIG. 10, it is assumed that a distance (arm length) from the waist position of the user to the head position at which the gyro sensor is mounted is r. The head moves to positions fixed at a radius r from the center of rotation, and, when the angular change of the head is θ and φ, the position (X, Y, Z) of the head seen from the user coordinate system in which the waist position is an origin can be expressed with the following equation (2).

[Math. 2]

X=r sin φ sin θ

Y=r cos θ

Z=r sin θ cos φ (2)

The position when θ=0, and φ=0 is X=0, Y=r and Z=0 in the user coordinate system. Therefore, by adding a change amount X′=r sin φ sin θ, Y′=r(cos θ−1), Z=r sin θ cos φ from the initial position to the position in the camera set in the application, it is possible to present motion parallax according to change of the position in a horizontal direction or in a longitudinal direction of the head of the user.

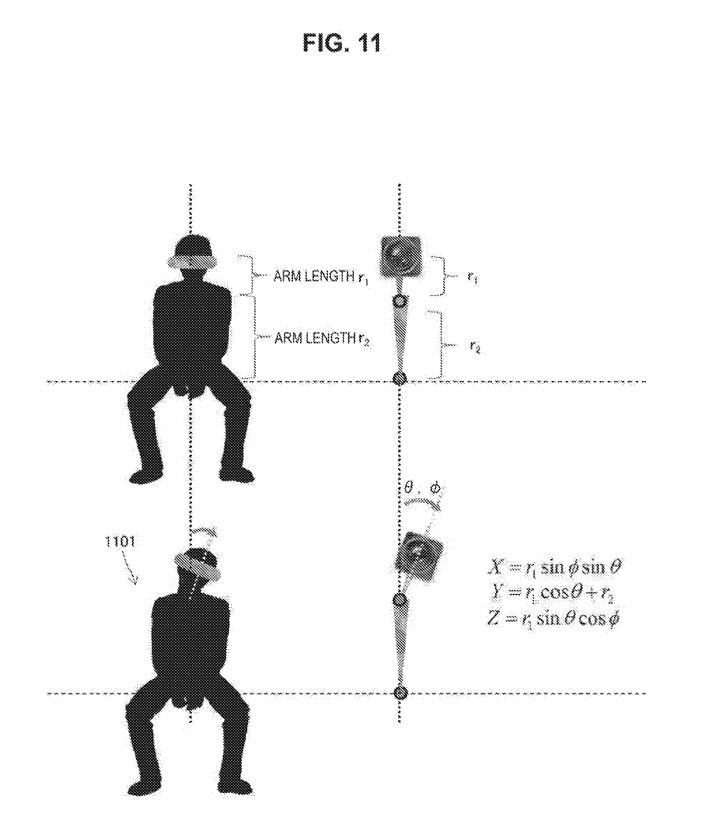

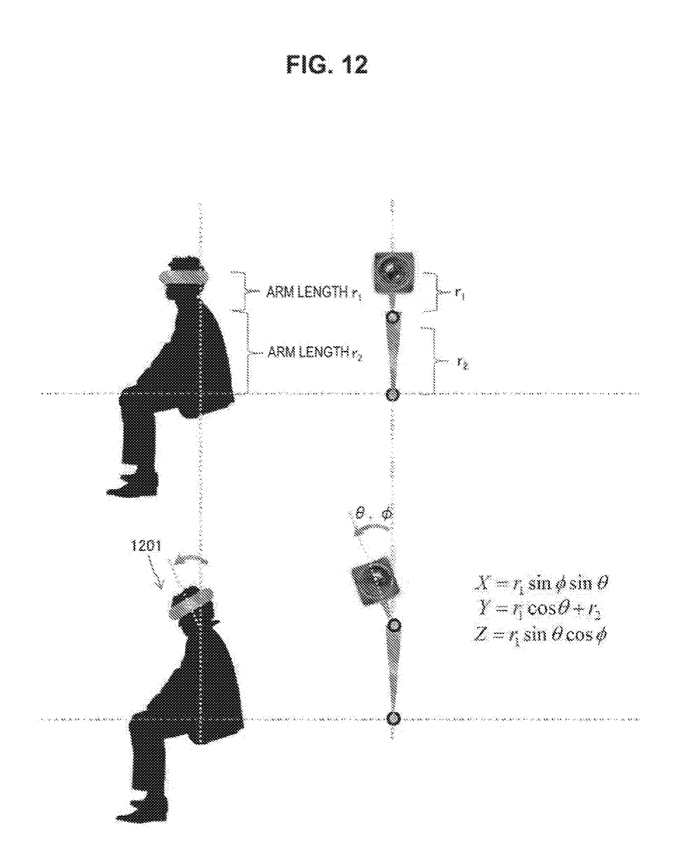

Subsequently, as illustrated in FIG. 11 and FIG. 12, a model in which the head of the sitting user rotates around the neck will be considered. However, FIG. 11 illustrates a case where the head of the user 1101 tilts leftward (to a right side on the paper) around the neck, while FIG. 12 illustrates a case where the head of the user 1201 tilts forward around the neck.

It is assumed that a distance (first arm length) from the neck of the user to the head position at which the gyro sensor is mounted is r₁, and a distance (second arm length) from the waist position to the neck of the user is r₂. The head moves to positions fixed at a radius r₁ from the neck which is the center of the rotation, and, when the angular change of the head is θ and φ, the position (X, Y, Z) of the head seen from the user coordinate system in which the waist position is an origin can be expressed with the following equation (3).

[Math. 3]

X=r₁ sin φ sin θ

Y=r₁ cos θ+r₂

Z=r₁ sin θ cos φ (3)

The position when θ=0, and φ=0 is X=0, Y=r₁+r₂, and Z=0 in the user coordinate system. Therefore, by adding a change amount X′=r₁ sin φ sin θ, Y′=r₁(cos θ−1)+r₂, and Z=r₁ sin θ cos φ from the initial position to the position in the camera set in the application, it is possible to present motion parallax according to change of the position of the head of the user in a horizontal direction or in a longitudinal direction. In a use case in which the model in which the head rotates around the neck is more suitable than the model in which the head rotates around the waist position, it is only necessary to use the above-described equation (3) in place of the above-described equation (2).

While the above-described arm length r, r₁ and r₂ are set based on a size of a human body, the arm lengths may be freely set by the application which renders the image.

For example, when it is desired to present motion parallax from a viewpoint of a huge robot, the arm lengths may be set according to the size of the assumed robot. Further, there is also a case where it is desired to finely adjust a value of the motion parallax for each application. In this case, it is also possible to adjust the value by further applying a linear or non-linear equation to the change amount of the position of the head calculated using the above-described equation (2) or (3) from the detected posture of the head.

Further, according to the application, presentation of only left and right motion of the head as illustrated in FIG. 9 and FIG. 11 is sufficient, and it is not necessary to present longitudinal motion of the head as illustrated in FIG. 10 and FIG. 12. In such a case, the posture angle calculating unit 202 (or the drawing processing unit 302) may fix θ=0 in the above-described equation (2) or (3) and obtain the position of the head by only utilizing φ obtained from the posture angle calculating unit 202 (in other words, it is also possible to utilize only a change amount in the X direction of the head).

It should be taken into account that the above-described equation (2) or (3) is not used for accurately obtaining the position of the head of the user, but for obtaining the position of the head in a simplified manner from the angular change of the head of the user, thus the result includes an error.

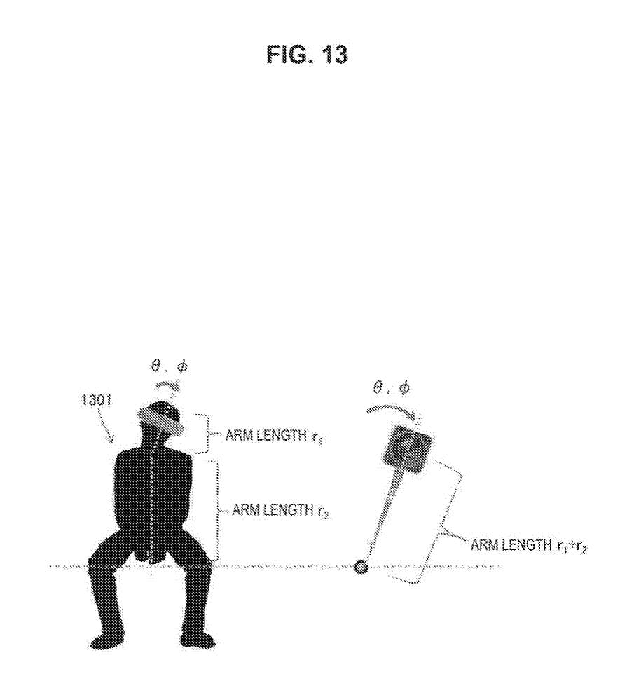

For example, a case will be described where, while a model is assumed in which the upper body of the sitting user 1301 rotates around the waist position as illustrated in FIG. 13, the actual user tilts his/her head around the neck in a horizontal direction.

When the angular change of the head is θ and φ, because the user moves his/her head around the neck, the actual position of the head seen from the user coordinate system is expressed with the following equation (4). On the other hand, the position of the head seen from the user coordinate system in which the waist position is an origin, calculated according to the model illustrated in FIG. 13 is expressed with the following equation (5). Therefore, the position of the head calculated according to the model illustrated in FIG. 13 includes an error (eₓ, e_{y}, e_{z}) as expressed in the following equation (6).

X=r₁ sin φ sin θ

Y=r₁ cos θ+r₂

Z=r₁ sin θ cos φ (4)

[Math. 5]

X=(r₁+r₂)sin φ sin θ

Y=(r₁+r₂)cos θ

Z=(r₁+r₂)sin θ cos φ (5)

[Math. 6]

eₓ=r₂ sin φ sin θ

e_{y}=r₂(cos θ−1)

e_{z}=r₂ sin θ cos φ (6)

As one way to address a case where the error (eₓ, e_{y}, e_{z}) becomes a problem, there is a method in which an upper limit is set to a movement amount to be added to the position in the camera set in the application. For example, the drawing processing unit 302 prevents occurrence of extreme deviation of motion parallax by applying motion parallax to only values for which the angular change θ and φ of the head output from the posture angle calculating unit 202 are respectively within ±45 degrees.

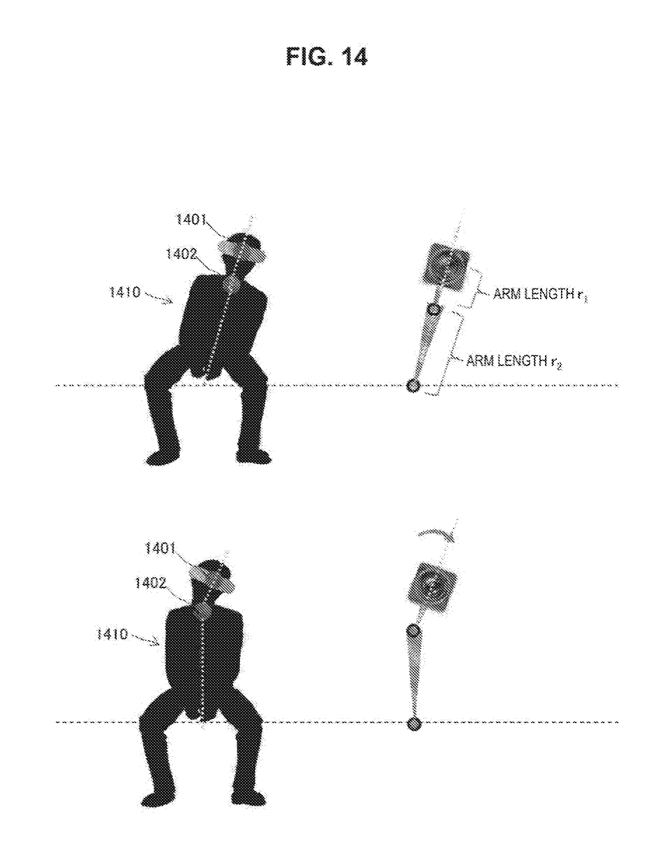

Further, there is also a method in which angular change at a portion of the upper body other than the head of the sitting user is further detected to obtain the position of the head more accurately. For example, as illustrated in FIG. 14, a model is assumed in which the upper body of the sitting user 1410 rotates around the waist and the head rotates around the neck. In this case, the sensor unit 201 includes a second gyro sensor 1402 worn on the neck of the user 1410 as well as a first gyro sensor 1401 worn on the head of the user 1410. The posture angle calculating unit 202 then integrates the angular velocity detected by the first gyro sensor 1401 to calculate rotation amounts θ₁, φ₁ of the head around the waist position, while integrating the angular velocity detected by the second gyro sensor 1402 to calculate rotation amounts θ₂, φ₂ of the neck around the waist position. The posture angle calculating unit 202 (or the drawing processing unit 302) then calculates the position (X, Y, Z) of the head seen from the coordinate system of the user 1410 in which the waist position is an origin as in the following equation (7).

[Math. 7]

X=r₁ sin φ₁ sin θ₁+r₂ sin φ₂ sin θ₂

Y=r₁ cos θ₁+r₂ cos θ₂

Z=r₁ sin θ₁ cos φ₁+r₂ sin θ₂ cos φ₂ (7)

According to the above-described equation (7), it is possible to obtain the position of the head of the user 1410 while taking into account respective rotation amounts around the neck and around the waist of the sitting user 1410.

Note that, in the example illustrated in FIG. 14, while the gyro sensors 1401 and 1402 are provided at two locations of the neck and the waist position of the sitting user 1410, when portions other than the neck and the waist position of the upper body of the user 1410 also rotate, it is possible to obtain the position of the head of the user 1410 more accurately by providing gyro sensors at three or more locations.

In the examples illustrated in FIG. 9 and FIG. 10, the position (X, Y, Z) of the head is obtained from the angular change of the head according to the above-described equation (2) while the arm length r from the origin of the user coordinate system set at the waist position of the user to the head position of the user at which the gyro sensor is mounted (that is, at which the posture is detected). As a modified example of these examples, it is also possible to obtain the head position of the user by estimating the arm length r at each time.

Combination use of the acceleration sensor with the gyro sensor as the sensor unit 201 has been described above. The gyro sensor can detect the angular velocity ω of the head of the user, and the acceleration sensor can detect acceleration a_{y} of the head. Here, when it is assumed that the head of the user circularly moves on a circumference of a radius r at constant angular velocity ω, the acceleration a_{y} of the head is centripetal acceleration, and the following equation (8) holds.

[Math. 8]

a_{y}=rω² (8)

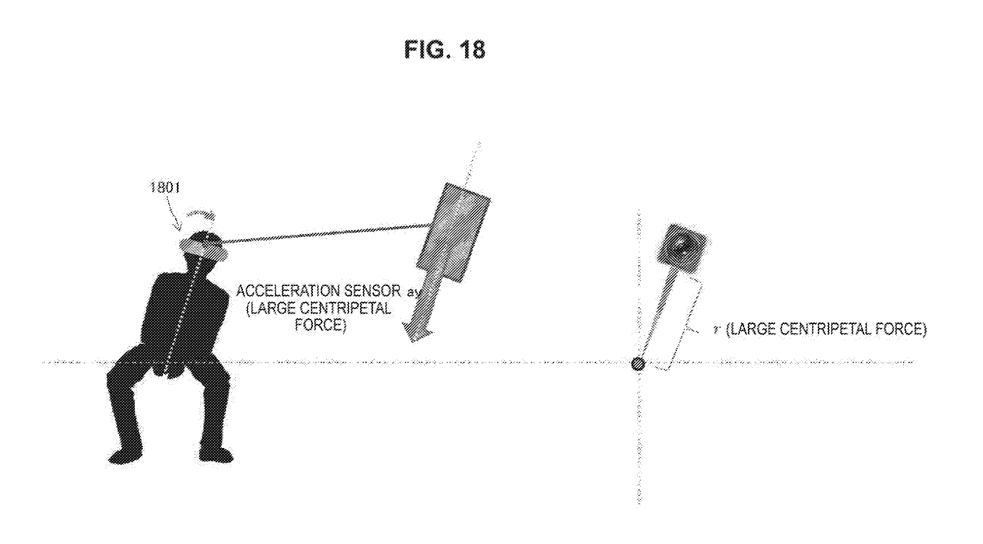

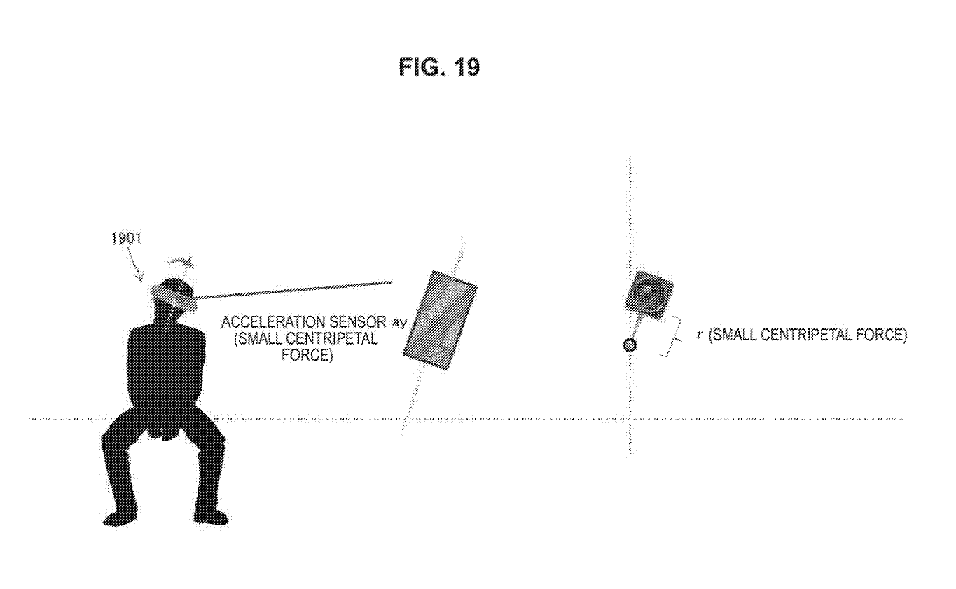

According to the above-described equation (8), even if the angular velocity is the same and co, because the acceleration increases in proportion to the radius from the center of the rotation, that is, the arm length r, the acceleration sensor can observe acceleration a_{y} of values different between when the head of the user rotates around the waist (see FIG. 9 and FIG. 10), and when the head rotates around the neck (see FIG. 11 and FIG. 12). As illustrated in FIG. 18, when the head of the user 1801 rotates around the waist, the arm length r becomes long, and a centripetal force applied to the head becomes large. On the other hand, as illustrated in FIG. 19, when the head of the user 1901 rotates around the neck, the arm length becomes short, and the centripetal force applied to the head becomes small. From the above-described equation (8), the arm length r can be obtained using the following equation (9).

$$\begin{matrix}[ Math . 9 ] & \\ r = \frac{{a}_{y}}{{ω}^{2}} & ( 9 )\end{matrix}$$

Therefore, when the position of the head of the user is obtained, it is possible to determine whether the head of the user rotates either around the neck or around the waist (or a position of the center of rotation of the rotation movement of the head) according to the length of the arm length r. By taking into account the rotation radius r obtained in the above-described equation (9), it is possible to accurately obtain the position of the head of the user and utilize the position for presentation of motion parallax.

According to the technology disclosed in this specification, it is possible to detect change of the position of the head of the user only with an inexpensive sensor like a gyro sensor. Particularly, when the technology disclosed in this specification is applied to a head-mounted display, it is not necessary to provide a sensor, a marker, or the like, outside the head-mounted display (in other words, at a position distant from the head-mounted display), so that it is possible to readily carry and utilize the head-mounted display.

The foregoing thus describes the technology disclosed in this specification in detail and with reference to specific embodiments. However, it is obvious that persons skilled in the art may make modifications and substitutions to these embodiments without departing from the spirit of the technology disclosed in this specification.

While the technology disclosed in this specification is particularly effective when the head motion tracking apparatus 200 is provided as an optional product externally attached to the display apparatus 400 configured as the head-mounted display, of course, also when the head motion tracking apparatus 200 is mounted within the body portion 41 of the display apparatus 400, the technology disclosed in this specification can be applied in a similar manner. Further, when the display apparatus 400 is a product other than the head-mounted display, the technology disclosed in this specification can be applied in a similar manner when an image following the motion of the head of the user is reproduced.

Further, while, in this specification, the embodiment in which motion parallax is presented at the head-mounted display has been mainly described, the technology disclosed in this specification can be applied to other use cases. For example, when a user who sits down in front of a large-screen display such as TV and plays a game, wears the head motion tracking apparatus 200, motion parallax can be presented on the game screen on TV.

While motion parallax can be presented by reflecting change of the head position detected by applying the technology disclosed in this specification to a 3D graphics camera viewpoint, the technology disclosed in this specification can be also utilized in other applications. For example, it is also possible to utilize the technology to a 2D graphics game to avoid an attack from an enemy according to the change of the position of the head.

Essentially, the technology disclosed in this specification has been described by way of example, and the stated content of this specification should not be interpreted as being limiting. The spirit of the technology disclosed in this specification should be determined in consideration of the claims.

Additionally, the present technology may also be configured as below.

(1)

A head position detecting apparatus including:

a detecting unit configured to detect posture of a head of a user; and

a converting unit configured to convert the posture of the head into a position of a head in a user coordinate system.

(2)

The head position detecting apparatus according to (1),

wherein the detecting unit includes a gyro sensor worn on the head of the user, and integrates angular velocity detected by the gyro sensor to calculate the posture of the head.

(3)

The head position detecting apparatus according to (2),

wherein the detecting unit further includes an acceleration sensor, and compensates for drift with respect to a gravity direction of the posture obtained from the gyro sensor based on a gravity direction detected by the acceleration sensor.

(4)

The head position detecting apparatus according to any of (1 to (3),

wherein the converting unit converts change of an angle of the head of the user into a position of a head seen from the user coordinate system in which an origin is set at a predetermined portion on a body of the user distant from the head by a predetermined arm length r.

(5)

The head position detecting apparatus according to (4),

wherein the converting unit converts the change of the angle of the head into the position of the head seen from the user coordinate system assuming that the head of the user moves on a spherical surface fixed at a predetermined radius r from a predetermined center of rotation.

(6)

The head position detecting apparatus according to (4),

wherein the converting unit converts the change of the angle of the head into the position of the head seen from the user coordinate system assuming that the head of the user moves on a spherical surface whose rotation center is an origin on the user coordinate system and which has a radius of the arm length r.

(7)

The head position detecting apparatus according to (4),

wherein a waist position of the user is set at an origin of the user coordinate system, and the converting unit converts the change of the angle of the head into the position of the head seen from the waist position of the user assuming that the head of the user moves on a spherical surface whose rotation center is the waist position of the user and which has a radius of the arm length r.

(8)

The head position detecting apparatus according to (4),

wherein the converting unit converts the change of the angle of the head into the position of the head seen from the user coordinate system assuming that the head of the user moves on a spherical surface fixed at a radius r₁ from a center of rotation distant by a first arm length r₁ which is shorter than the arm length r.

(9)

The head position detecting apparatus according to (4),

wherein a waist position of the user is set at an origin of the user coordinate system, and

the converting unit converts the change of the angle of the head into the position of the head seen from the waist position of the user assuming that the head of the user moves on a spherical surface fixed at a radius r₁ from a neck distant by a first arm length r₁ which is shorter than the arm length r.

(10)

The head position detecting apparatus according to (1), further including:

a second detecting unit configured to detect posture of a portion of an upper body other than the head of the user,

wherein the converting unit converts the posture of the head into the position of the head in the user coordinate system based on the posture of the head detected by the detecting unit and the posture of the portion of the upper body detected by the second detecting unit.

(11)

The head position detecting apparatus according to (4),

wherein the converting unit adjusts the arm length r according to an application to which the position of the head is to be applied.

(12)

The head position detecting apparatus according to any of (1 to (11),

wherein the converting unit obtains the position of the head while limiting at least part of angular components of the posture of the head detected by the detecting unit according to an application to which the position of the head is to be applied.

(13)

The head position detecting apparatus according to (4),

wherein the converting unit obtains a position of a head at each time by estimating the arm length r at each time.

(14)

The head position detecting apparatus according to (13),

wherein the detecting unit includes a sensor configured to detect acceleration of the head of the user, and

the converting unit obtains the position of the head at each time by estimating the arm length r based on the acceleration detected at each time.

(15)

A head position detecting method including:

a detecting step of detecting posture of a head of a user; and

a converting step of converting the posture of the head into a position of a head in a user coordinate system.

(16)

An image processing apparatus including:

a detecting unit configured to detect posture of a head of a user;

a converting unit configured to convert the posture of the head into a position of a head in a user coordinate system; and

a drawing processing unit configured to generate an image in which motion parallax corresponding to the position of the head is presented.

(16-1)

The image processing apparatus according to (16),

wherein the detecting unit includes a gyro sensor worn on the head of the user, and integrates angular velocity detected by the gyro sensor to calculate the posture of the head.

(16-2)

The image processing apparatus according to (16-1),

wherein the detecting unit further includes an acceleration sensor, and compensates for drift with respect to a gravity direction of the posture obtained from the gyro sensor based on a gravity direction detected by the acceleration sensor.

(16-3)

The image processing apparatus according to any of (16-1) to (16-2)),

wherein the converting unit converts change of an angle of the head of the user into a position of a head seen from the user coordinate system in which an origin is set at a predetermined portion on a body of the user distant from the head by a predetermined arm length r.

(16-4)

The image processing apparatus according to (16-3),

wherein the converting unit converts the change of the angle of the head into the position of the head seen from the user coordinate system assuming that the head of the user moves on a spherical surface fixed at a predetermined radius r from a predetermined center of rotation.

(16-5)

The image processing apparatus according to (16-3),

wherein the converting unit converts the change of the angle of the head into the position of the head seen from the user coordinate system assuming that the head of the user moves on a spherical surface whose rotation center is an origin on the user coordinate system and which has a radius of the arm length r.

(16-6)

The image processing apparatus according to (16-3),

wherein a waist position of the user is set at an origin of the user coordinate system, and the converting unit converts the change of the angle of the head into the position of the head seen from the waist position of the user assuming that the head of the user moves on a spherical surface whose rotation center is the waist position of the user and which has a radius of the arm length r.

(16-7)

The image processing apparatus according to (16-3),

wherein the converting unit converts the change of the angle of the head into the position of the head seen from the user coordinate system assuming that the head of the user moves on a spherical surface fixed at a radius r₁ from a center of rotation distant by a first arm length r₁ which is shorter than the arm length r.

(16-8)

The image processing apparatus according to (16-3),

wherein a waist position of the user is set at an origin of the user coordinate system, and

the converting unit converts the change of the angle of the head into the position of the head seen from the waist position of the user assuming that the head of the user moves on a spherical surface fixed at a radius r₁ from a neck distant by a first arm length r₁ which is shorter than the arm length r.

(16-9)

The image processing apparatus according to (16), further including:

a second detecting unit configured to detect posture of a portion of an upper body other than the head of the user,

wherein the converting unit converts the posture of the head into the position of the head in the user coordinate system based on the posture of the head detected by the detecting unit and the posture of the portion of the upper body detected by the second detecting unit.

(16-10)

The image processing apparatus according to (16-3),

wherein the converting unit adjusts the arm length r according to an application to which the position of the head is to be applied.

(16-11)

The image processing apparatus according to any of (16) to (16-10),

wherein the converting unit obtains the position of the head while limiting at least part of angular components of the posture of the head detected by the detecting unit according to an application to which the position of the head is to be applied.

(16-12)

The image processing apparatus according to (16-3),

wherein the converting unit obtains a position of a head at each time by estimating the arm length r at each time.

(16-13)

The image processing apparatus according to (16-12),

wherein the detecting unit includes a sensor configured to detect acceleration of the head of the user, and

the converting unit obtains the position of the head at each time by estimating the arm length r based on the acceleration detected at each time.

(17)

The image processing apparatus according to (16),

wherein the drawing processing unit applies motion parallax to only values for which angular change of the head is within a predetermined value.

(18)

An image processing method including:

a detecting step of detecting posture of a head of a user;

a converting step of converting the posture of the head into a position of a head in a user coordinate system; and

a drawing processing step of generating an image in which motion parallax corresponding to the position of the head is presented.

(19)

A display apparatus including:

a detecting unit configured to detect posture of a head of a user;

a converting unit configured to convert the posture of the head into a position of a head in a user coordinate system;

a drawing processing unit configured to generate an image in which motion parallax corresponding to the position of the head is presented; and

a display unit.

(20)

A computer program described in a computer readable form so as to cause a computer to function as:

a converting unit configured to convert posture of a head detected by a detecting unit worn on the head of a user into a position of a head in a user coordinate system; and

a drawing processing unit configured to generate an image in which motion parallax corresponding to the position of the head is presented.

### REFERENCE SIGNS LIST

41 body portion
42 forehead protecting portion
43 nose pad portion
44 upper band
45 lower band
100 image display system
200 head motion tracking apparatus
201 sensor unit
202 posture angle calculating unit
203 transmitting unit
300 drawing apparatus
301 receiving unit
302 drawing processing unit
303 transmitting unit
304 image source
400 display apparatus
401 receiving unit
402 display unit

1. A head position detecting apparatus comprising:
a detecting unit configured to detect posture of a head of a user; and
a converting unit configured to convert the posture of the head into a position of a head in a user coordinate system.

2. The head position detecting apparatus according to claim 1,
wherein the detecting unit includes a gyro sensor worn on the head of the user, and integrates angular velocity detected by the gyro sensor to calculate the posture of the head.

3. The head position detecting apparatus according to claim 2,
wherein the detecting unit further includes an acceleration sensor, and compensates for drift with respect to a gravity direction of the posture obtained from the gyro sensor based on a gravity direction detected by the acceleration sensor.

4. The head position detecting apparatus according to claim 1,
wherein the converting unit converts change of an angle of the head of the user into a position of a head seen from the user coordinate system in which an origin is set at a predetermined portion on a body of the user distant from the head by a predetermined arm length r.

5. The head position detecting apparatus according to claim 4,
wherein the converting unit converts the change of the angle of the head into the position of the head seen from the user coordinate system assuming that the head of the user moves on a spherical surface fixed at a predetermined radius r from a predetermined center of rotation.

6. The head position detecting apparatus according to claim 4,
wherein the converting unit converts the change of the angle of the head into the position of the head seen from the user coordinate system assuming that the head of the user moves on a spherical surface whose rotation center is an origin on the user coordinate system and which has a radius of the arm length r.

7. The head position detecting apparatus according to claim 4,
wherein a waist position of the user is set at an origin of the user coordinate system, and
the converting unit converts the change of the angle of the head into the position of the head seen from the waist position of the user assuming that the head of the user moves on a spherical surface whose rotation center is the waist position of the user and which has a radius of the arm length r.

8. The head position detecting apparatus according to claim 4,
wherein the converting unit converts the change of the angle of the head into the position of the head seen from the user coordinate system assuming that the head of the user moves on a spherical surface fixed at a radius r₁ from a center of rotation distant by a first arm length r₁ which is shorter than the arm length r.

9. The head position detecting apparatus according to claim 4,
wherein a waist position of the user is set at an origin of the user coordinate system, and
the converting unit converts the change of the angle of the head into the position of the head seen from the waist position of the user assuming that the head of the user moves on a spherical surface fixed at a radius r₁ from a neck distant by a first arm length r₁ which is shorter than the arm length r.

10. The head position detecting apparatus according to claim 1, further comprising:
a second detecting unit configured to detect posture of a portion of an upper body other than the head of the user,
wherein the converting unit converts the posture of the head into the position of the head in the user coordinate system based on the posture of the head detected by the detecting unit and the posture of the portion of the upper body detected by the second detecting unit.

11. The head position detecting apparatus according to claim 4,
wherein the converting unit adjusts the arm length r according to an application to which the position of the head is to be applied.

12. The head position detecting apparatus according to claim 1,
wherein the converting unit obtains the position of the head while limiting at least part of angular components of the posture of the head detected by the detecting unit according to an application to which the position of the head is to be applied.

13. The head position detecting apparatus according to claim 4,
wherein the converting unit obtains a position of a head at each time by estimating the arm length r at each time.

14. The head position detecting apparatus according to claim 13,
wherein the detecting unit includes a sensor configured to detect acceleration of the head of the user, and
the converting unit obtains the position of the head at each time by estimating the arm length r based on the acceleration detected at each time.

15. A head position detecting method comprising:
a detecting step of detecting posture of a head of a user; and
a converting step of converting the posture of the head into a position of a head in a user coordinate system.

16. An image processing apparatus comprising:
a detecting unit configured to detect posture of a head of a user;
a converting unit configured to convert the posture of the head into a position of a head in a user coordinate system; and
a drawing processing unit configured to generate an image in which motion parallax corresponding to the position of the head is presented.

17. The image processing apparatus according to claim 16,
wherein the drawing processing unit applies motion parallax to only values for which angular change of the head is within a predetermined value.

18. An image processing method comprising:
a detecting step of detecting posture of a head of a user;
a converting step of converting the posture of the head into a position of a head in a user coordinate system; and
a drawing processing step of generating an image in which motion parallax corresponding to the position of the head is presented.

19. A display apparatus comprising:
a detecting unit configured to detect posture of a head of a user;
a converting unit configured to convert the posture of the head into a position of a head in a user coordinate system;
a drawing processing unit configured to generate an image in which motion parallax corresponding to the position of the head is presented; and
a display unit.

20. A computer program described in a computer readable form so as to cause a computer to function as:
a converting unit configured to convert posture of a head detected by a detecting unit worn on the head of a user into a position of a head in a user coordinate system; and
a drawing processing unit configured to generate an image in which motion parallax corresponding to the position of the head is presented.
